(19) United States
(12) Patent Application Publication
(10) Pub. No.: US 2025/0190741 A1
(43) Pub. Date: Jun. 12, 2025

(54) QUESTION ANSWERING SYSTEM AND METHOD BASED ON COMPLEX REASONING PIPELINE

(71) Applicant: ELECTRONICS AND TELECOMMUNICATIONS RESEARCH INSTITUTE, Daejeon (KR)

(72) Inventors: Minho Kim, Daejeon (KR); Jihyeon Roh, Daejeon (KR); Kyungman Bae, Daejeon (KR); HyunKi Kim, Daejeon (KR); YONGJIN BAE, Daejeon (KR); Hyung Jik Lee, Daejeon (KR); Myung Gil Jang, Daejeon (KR)

(21) Appl. No.: 18/911,414

(22) Filed: Oct. 10, 2024

(30) Foreign Application Priority Data
Dec. 7, 2023 (KR) 10-2023-0176668

(51) Int. Cl. G06N 3/006

(52) U.S. Cl. CPC G06N 3/006

(57) ABSTRACT

Provided are a question answering (QA) system and method based on a complex reasoning pipeline. The QA method includes classifying a reasoning type of an input question, generating sub-questions by decomposing the input question, inputting the sub-questions to a reasoning pipeline corresponding to the reasoning type, and outputting a final answer corresponding to the input sub-questions from the reasoning pipeline.

### CROSS-REFERENCE TO RELATED APPLICATION

This application claims priority to and the benefit of Korean Patent Application No. 10-2023-0176668, filed on Dec. 7, 2023, the disclosure of which is incorporated herein by reference in its entirety.

### BACKGROUND

### 1. Field of the Invention

The present invention relates to a question answering (QA) system and method based on a complex reasoning pipeline.

### 2. Description of Related Art

The field of natural language processing is undergoing rapid development with the advent of pretrained language models, and improvements are being made in complex evaluation sets and question answering (QA) methodologies. In the field of QA, complexity has increased from fill-in-the-blank to evaluation sets including natural language questions, and open-domain QA (ODQA) and multi-hop QA tasks have appeared. In particular, bridge-type multi-hop QA requires a chain of reasoning, and it is necessary to break a question into sub-questions and utilize key clues in sequence.

The recent advent of large language models has improved QA methodologies, but there are issues of hallucination, knowledge being outdated, and the like. Large language models have difficulty handling various types of QA and require a specific reasoning pipeline and various tasks for the purpose.

In particular, small and medium-sized language models with fine-tuned training may outperform very large language models, and large language models are very expensive to operate. In consideration of these problems, it is necessary to consider the use and development of large language models.

### SUMMARY OF THE INVENTION

The present invention is directed to providing a question answering (QA) system and method based on a complex reasoning pipeline in which a reasoning type of an input question may be recognized, a reasoning method may be determined according to the reasoning type, and then complex reasoning including a chain of reasoning may be performed.

Objects of the present invention are not limited to those described above, and other objects may exist.

According to an aspect of the present invention, there is provided a QA method based on a complex reasoning pipeline, the method including classifying a reasoning type of an input question, generating sub-questions by decomposing the input question, inputting the sub-questions to a reasoning pipeline corresponding to the reasoning type, and outputting a final answer corresponding to the input sub-questions from the reasoning pipeline. Here, the reasoning pipeline includes a search module configured to perform a search corresponding to each of the decomposed sub-questions and a document reading module configured to perform a document reading process according to search results.

According to another aspect of the present invention, there is provided a QA system based on a complex reasoning pipeline, the system including an input part configured to receive a question, a memory in which a program for inferring from the received question and outputting an answer is stored, and a processor configured to execute the program stored in the memory. When the program is executed, the processor classifies a reasoning type of the received question, generates sub-questions by decomposing the received question, inputs the sub-questions to a reasoning pipeline corresponding to the reasoning type, and outputs a final answer corresponding to the input sub-questions from the reasoning pipeline. Here, the reasoning pipeline includes a search module configured to perform a search corresponding to each of the decomposed sub-questions and a document reading module configured to perform a document reading process according to search results.

According to another aspect of the present invention, there is provided a computer program for executing the QA method based on a complex reasoning pipeline in combination with a computer which is hardware, the computer program being stored in a computer-readable recording medium.

Other details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a question answering (QA) system based on a complex reasoning pipeline according to an exemplary embodiment of the present invention;

FIG. 2 is a diagram illustrating the concept of open-domain QA (ODQA);

FIG. 3 is a flowchart of a QA inference method according to the exemplary embodiment of the present invention;

FIG. 4 is a diagram illustrating a QA inference method according to the exemplary embodiment of the present invention;

FIG. 5 is a diagram of a first example of an intersectional reasoning pipeline according to the exemplary embodiment of the present invention;

FIG. 6 is a diagram of a second example of an intersectional reasoning pipeline according to the exemplary embodiment of the present invention;

FIG. 7 is a diagram of an example of a comparative reasoning pipeline according to the exemplary embodiment of the present invention;

FIG. 8 is a diagram of an example of a simple bridge reasoning pipeline according to the exemplary embodiment of the present invention;

FIG. 9 is a diagram of an example of a single-hop pipeline according to the exemplary embodiment of the present invention; and

FIG. 10 is a diagram of an example of a distracted single-hop retrieval reasoning pipeline according to the exemplary embodiment of the present invention.

### DETAILED DESCRIPTION OF EXEMPLARY EMBODIMENTS

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims.

Terminology used herein is for describing the embodiments and is not intended to limit the present invention. In this specification, singular forms also include plural forms unless specifically stated otherwise. As used herein, “comprises” and/or “comprising” do not preclude the presence or addition of one or more components other than stated components. Throughout the specification, like reference numerals refer to like components, and the term “and/or” includes any or all combinations of stated components. Although “first,” “second,” and the like are used to describe various components, the components are not limited by the terms. These terms are only used to distinguish one component from others. Accordingly, a first component described below may be a second component without departing from the technical spirit of the present invention.

Unless otherwise defined, all terms (including technical and scientific terms) may have meanings generally understood by those skilled in the technical field to which the present invention pertains. Also, unless clearly defined, all terms defined in generally used dictionaries are not to be ideally or excessively interpreted.

Hereinafter, a background in which the present invention has been deduced will be described first to help understanding by those of ordinary skill in the art, and then the present invention will be described in detail.

The field of natural language processing is undergoing rapid development with the development of pretrained language models. Accordingly, complex evaluation sets are being developed to evaluate higher linguistic intelligence, and methods for the purpose are being proposed.

In the field of question answering (QA), complexity has increased from fill-in-the-blank questions, which are the simplest questions, to evaluation sets including natural language questions. Machine comprehension in which an answer is searched for when a paragraph including the answer is given, has evolved into open-domain QA (ODQA) in which a paragraph for finding an answer is automatically searched for to find the answer. Complexity has increased from single-hop QA in which an answer may be found through a single search to multi-hop QA in which an answer may be found through several searches.

Particularly, a bridge-type one of multi-hop QA tasks requires a chain of reasoning to find an answer. For example, it is necessary to decompose a given complex question into two or more sub-questions on the basis of bridge anaphors. Also, to find a final answer, it is necessary to have a sequence of the sub-questions and provide an answer of a preceding sub-question as a key clue to solving the subsequent sub-question. In other words, a chain of reasoning is performed to find an answer.

With the recent advent of large language models, QA methodologies for such complex questions are being improved. A chain of reasoning which was unattainable due to technical limitations has been enabled to realize substantial performance improvement. However, large language models have some issues.

A first issue is about hallucinations. There have been reports of the inference process producing spurious inferences which are not actually true. Also, large language models have a problem in that knowledge is easily outdated. This is because once learning is performed, large language models do not reflect newly generated knowledge any more. In addition, due to huge learning costs, it is difficult to update parameters of a language model using new knowledge.

Although complex questions which have been difficult to answer are answered by large language models and QA performance has been improved, large language models are not omnipotent. Complex questions include very various types of questions. Examples of complex questions include simple type of questions, general bridge questions, comparative questions, distracted questions, single-hop retrieval questions, simple single-hop retrieval questions, questions which are actually bridge questions but faked as simple single-hop retrieval questions, and the like. One large language model cannot handle these many types of questions with high performance. Rather, it is necessary to identify types of questions and provide an optimized reasoning pipeline for each type of question.

Also, according to a method of the related art, a task of decomposing a complex question or restructuring a question is handled by a single large language model. Complex questions may also require recognizing a reasoning type of a question, knowledge retrieval, document reading, response confidence level evaluation, question conversion, and the like. It is naturally difficult for a single language model to outperform models separately optimized for tasks.

A large language model that is not fine-tuned does not ensure high performance or optimized performance. Rather, a small or medium-sized language model that is fine tuned shows higher performance than an ultra-large language model that is several hundreds of times larger than the small or medium-sized language model or more.

Another problem of large language models is that operational costs are very high. This is because the number of parameters in a large language model is very large, and the operational cost increases with the running of the model. For example, GPT-3 has 175 billion model parameters, whereas T5-base and large models have 220 and 770 million model parameters. This shows size ratios of about 800 and 250 times. When fine tuning is performed, the cost drastically increases.

A QA system and method based on a complex reasoning pipeline according to embodiments of the present invention provides a QA system for complex reasoning in open domains using a small or medium-sized language model.

First, an exemplary embodiment of the present invention mitigates the problems of hallucination and knowledge being outdated in existing large language models with complex reasoning capability. To this end, the basic frame “read-then-retrieve” is applied. Also, to effectively handle a situation in which it is necessary to provide separate complex solutions to various types of complex questions, reasoning pipelines that may recognize types of questions and are separately optimized for types of questions are provided. Further, a separate module for question restructuring, such as decomposing a complex question into sub-questions on which a chain of reasoning may be performed, generating auxiliary questions, and the like, according to each type of question is provided. According to the present invention, to determine an optimal action for a next operation, an answer may be evaluated, and whether to proceed to the next operation may be determined. Optimized reasoning pipelines are separately subjected to fine tuning according to types thereof to achieve high performance. In addition, according to an exemplary embodiment of the present invention, small and medium-sized models may be used to solve the problem of a high running cost of a large language model.

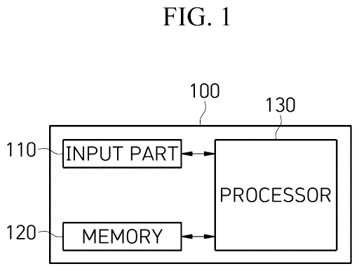

FIG. 1 is a block diagram of a QA system based on a complex reasoning pipeline according to an exemplary embodiment of the present invention.

A QA system 100 according to an exemplary embodiment of the present invention includes an input part 110, a memory 120, and a processor 130.

The input part 110 generates input data according to a user input of the QA system 100. The user input may include a user input about data to be processed by the QA system 100. For example, the input part 110 receives a question. The input part 110 includes at least one input device. The input part 110 may include a keyboard, a keypad, a dome switch, a touch panel, a touch key, a mouse, a menu button, and the like.

In the memory 120, a program for inferring from the received question and outputting an answer is stored. Here, the memory 120 collectively refers to a non-volatile storage device which continuously maintains stored information without power and a volatile storage device. For example, the memory 120 may include a NAND flash memory, such as a compact flash (CF) card, a secure digital (SD) card, a memory stick, a solid-state drive (SSD), and a micro SD card, a magnetic computer memory device, such as a hard disk drive (HDD) and the like, an optical disc drive, such as a compact disc read-only memory (CD-ROM), a digital video disc (DVD)-ROM, and the like, and the like.

The processor 130 may execute software, such as a program, to control at least one other component of the QA system 100 (e.g., a hardware or software component) and may perform various data processing or computations.

When a program is executed, the processor 130 classifies the received question into a reasoning type, generates sub-questions by decomposing the received question, and inputs the sub-questions to a reasoning pipeline corresponding to the reasoning type to output a final answer corresponding to the input sub-questions from the reasoning pipeline.

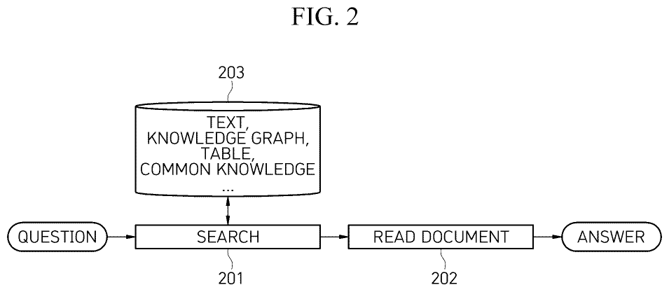

A method performed by the QA system 100 based on a complex reasoning pipeline according to an exemplary embodiment of the present invention will be described below with reference to FIGS. 2 to 10.

FIG. 2 is a diagram illustrating the concept of open-domain QA (ODQA).

ODQA basically incorporates a search operation 201 into a problem-solving process. The reason is that, in this task, a question is solved by externally retrieving knowledge required for QA.

A first operation of ODQA is the search operation 201. When a user provides a question, a large database 203 or web is searched for related information (201). The search operation 201 is an initial operation for finding candidate answers for the user's question.

A second operation is a document reading (or machine reading comprehension) operation 202 of actually reading and understanding documents or paragraphs including candidate answers obtained in the search operation 201. In this operation, the documents may be read using a natural language processing technology, and an answer to the question may be extracted or generated.

As shown in FIG. 2, the QA system according to the exemplary embodiment of the present invention also includes basic modules of the search operation 201 and the document reading operation 202. Blocks of search, document reading, question conversion, confidence level evaluation, and the like shown in each drawing may be understood as functional modules executed by the processor 130.

Table 1 below shows types of questions.

TABLE 1

| Type of question | Example |
|---|---|
| Comparative question | Who has more LPGA wins between Seri Park and |
| | Inbee Park? |
| Intersectional question | Which sports team had Case McCoy and Colt |
| | McCoy together? |
| Simple bridge question | In which city the university where President Joe |
| | Biden earned his undergraduate degree is located? |
| Simple single-hop | Where was Sir Isaac Newton born? |
| retrieval question | |
| Faked single-hop | In which city Marine Tactical Air Command |
| retrieval question | Squadron 28 is located? |
| Distracted single-hop | In which TV series did the actress Jiwon Kim, |
| retrieval question | one of the stars of “What's up,” come |
| | to prominence? |

There are many different types of questions that may be encountered in the real world. Depending on the number of searches required for finding an answer, a question may be classified as a single-hop retrieval question which involves one search to find an answer or a multi-hop retrieval question which involves several searches. Depending on a method of processing QA, a question may be classified as a simple single-hop retrieval question which involves a single search and reading to find an answer, a comparative question which involves comparing attributes of two entities, or an intersectional question which involves finding an answer from an intersection of two or more sets. In addition, the case of searching for a bridge entity first and searching for a final answer using the bridge entity may be classified as a bridge question. Particularly, when it is clearly necessary to search a question itself for a bridge entity, the question is defined as a simple bridge question.

Among questions that look like those with a simple condition, such as single-hop retrieval questions, there are faked single-hop retrieval questions which involve searching for a bridge entity to find a desired final answer. On the other hand, there are distracted single-hop retrieval questions which look like that multiple searches are necessary to find an answer because multiple conditions are included, but it is actually necessary to use only one of sub-questions to find an answer.

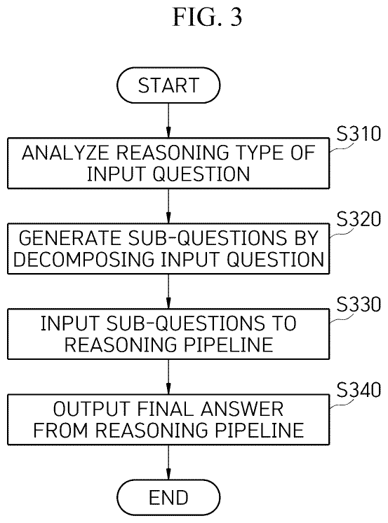

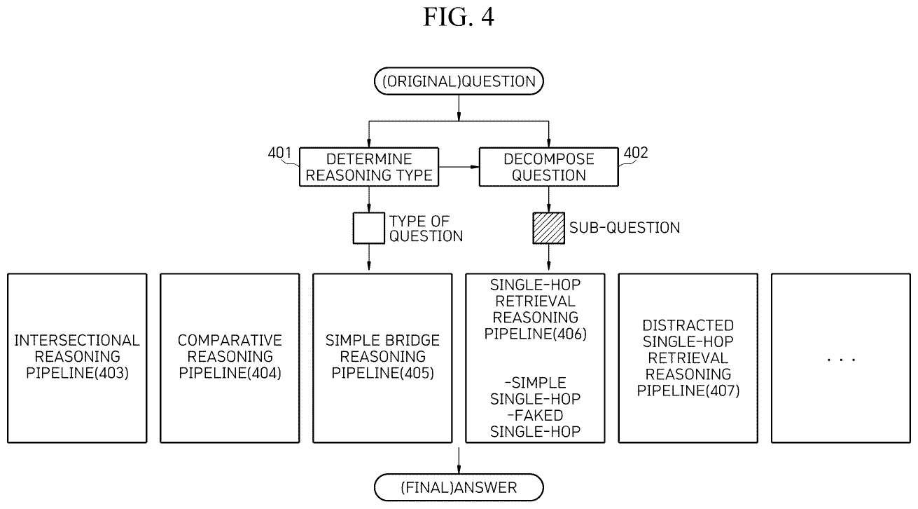

FIG. 3 is a flowchart of a QA inference method according to an exemplary embodiment of the present invention. FIG. 4 is a diagram illustrating a QA inference method according to the exemplary embodiment of the present invention.

According to the exemplary embodiment of the present invention, to handle these various types of complex questions, an input question is classified as a reasoning type (S310 and 401), and sub-questions are generated by decomposing the input question (S320 and 402).

According to the exemplary embodiment of the present invention, operations S310 and S320 may be simultaneously performed by one module or separately performed by separate modules. Also, the reasoning type may be determined first (401), and then the question may be decomposed (402), or the question may be decomposed first (402), and then the reasoning type may be determined (401). In addition, in operation 402 of decomposing the question, the question may or may not be decomposed depending on the reasoning type.

According to the exemplary embodiment of the present invention, reasoning types may be comparison, intersection, simple bridge, single-hop retrieval, and distracted single-hop retrieval.

The main feature of the present invention is that it is unnecessary to apply a large language model to allow a chain of reasoning. This is because detailed main functions are classified as reasoning type determination, question decomposition, search, document reading, answer selecting, confidence level evaluation, and the like, and it is possible to apply a small or medium-sized language model optimized for each function rather than a large language model which functions but may show low performance. With regard to tasks with simple and clear functions, a small or medium-sized language model subjected to fine tuning may outperform a large language model. In addition, since a small or medium-sized language model is used, a running cost can be significantly reduced.

Further, it is possible to easily add reasoning types in addition to reasoning types that have been provided in advance. The reason is that models included in the system to determine a reasoning type and decompose a question are very light compared to large language models and thus, when an additional reasoning type is detected, can be subjected to fine tuning required for optimal performance far more conveniently compared to large language models. In addition, with only simple addition of an optimized reasoning pipeline for the additional reasoning type, the reasoning pipeline can operate in the system.

Subsequently, according to the exemplary embodiment of the present invention, the sub-questions are input to a reasoning pipeline corresponding to the reasoning type (S330), and a final answer corresponding to the input sub-questions is output from the reasoning pipeline (S340).

According to the present invention, an optimal reasoning pipeline is provided for each of various reasoning types. In other words, it is possible to infer an answer through a pipeline for providing optimal performance for each reasoning type.

Meanwhile, the exemplary embodiment of the present invention is intended for open domains and thus includes a process of searching for a document and interpreting a found document. Accordingly, all types of reasoning pipelines include search and document reading modules.

Here, the search module selects top K search results on the basis of search scores. The selected top K documents are transmitted to the document reading module. The document reading module infers an answer from the top K documents. At this time, all the top K documents may be simultaneously input to infer the answer. Alternatively, the top K documents may be input one by one at a time to infer an answer candidates, and then one of the candidates with the highest confidence level score may be inferred as a final answer. Naturally, one or more final answers may be inferred.

According to the exemplary embodiment of the present invention, each reasoning pipeline is a set of external tools. Therefore, another reasoning pipeline may be built using external tools other than those illustrated in the present invention to achieve optimal performance of each pipeline. In addition, a new reasoning type may be added, and a new reasoning pipeline may be added for the new type. In other words, it is possible to easily add pipelines for reasoning types other than those proposed in the present invention using external tools in combination.

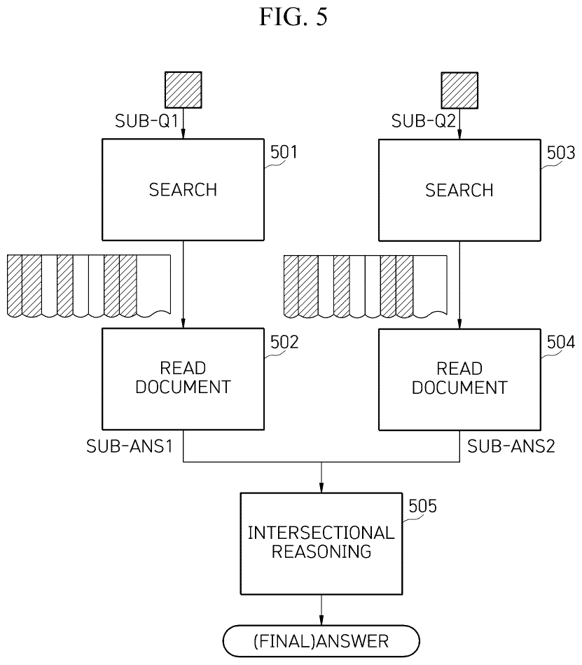

Different reasoning pipelines that are applicable according to reasoning types in an exemplary embodiment of the present invention will be described below with reference to FIGS. 5 to 10.

FIG. 5 is a diagram of a first example of an intersectional reasoning pipeline according to the exemplary embodiment of the present invention.

According to an exemplary embodiment, when a reasoning type of an input question is intersection, search operations 501 and 503 each corresponding to a plurality of sub-questions and document reading operations 502 and 504 based on the search results may be performed to generate a plurality of intermediate inferred answers, and an intersectional reasoning operation 505 may be performed on the plurality of intermediate inferred answers to output a final answer.

Referring to the example of FIG. 5, first, the search operations 501 and 503 and the document reading operations 502 and 504 are performed for two sub-questions Sub-Q1 and Sub-Q2, respectively. Then, answers to the sub-questions, that is, intermediate inferred answers Sub-Ans1 and Sub-Ans2, may be inferred. Subsequently, a final answer may be acquired through the intersectional reasoning operation 505 of the intermediate inferred answers. Also, in the intersectional reasoning operation 505, a search result for the first sub-question Sub-Q1 and a search result for the second sub-question Sub-Q2 may be additionally input to output a final answer.

For example, the question “Which sports team had Case McCoy and Colt McCoy together?” shown in Table 1 may be decomposed into the sub-questions “Which sports team had Case McCoy?” and “Which sports team had Colt McCoy?” (question decomposition). When a search and document reading is performed for the first sub-question Sub-Q1 “Which sports team had Case McCoy?,” the intermediate inferred answer Sub-Ans1 “{Graham (Texas), University of Texas}” may be obtained. When a search and document reading is performed for the second sub-question Sub-Q2 “Which sports team had Colt McCoy?,” the intermediate inferred answer Sub-Ans2 “{Jim Ned, University of Texas, Cleveland Browns, Washington Redskins, . . . }” may be obtained. When intersectional reasoning is performed on the intermediate inferred answers, the final answer “the University of Texas” may be obtained.

As another example, it is assumed that the question “Which actor of Home and Away played the lead role in Office Upspring?” is given. For the first sub-question Sub-Q1 “Who were the lead actors in Office Upspring?,” the intermediate inferred answer “{Brenton Thwaites, Jane Levy, Karan Soni, . . . } may be obtained, and for the second sub-question Sub-Q2 “Who were the actors in Home and Away?,” the intermediate inferred answer “{Brenton Thwaites, Emily Weir}” may be obtained. A final answer obtained through intersectional reasoning is “Brenton Thwaites.”

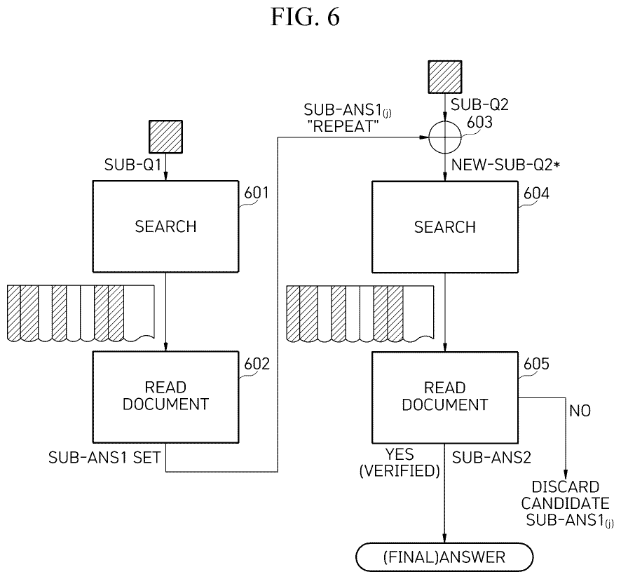

FIG. 6 is a diagram of a second example of an intersectional reasoning pipeline according to the exemplary embodiment of the present invention.

When a reasoning type of an input question is intersection, a method illustrated in FIG. 6 may be applied as another method of inferring an answer to the intersectional question. For example, a search operation 601 for a first sub-question and a document reading operation 602 based on the search result may be performed to generate a first candidate inferred answer set. Subsequently, each first candidate inferred answer is combined with a bridge anaphor of a second sub-question for verifying the first candidate inferred answer set to generate a new verification question. Then, a search operation 604 may be performed for the new verification question, and an inference passed through a document reading operation 605 for verification based on the search result may be determined as a final answer.

Referring to the example of FIG. 6, a candidate inferred answer set is generated for a first sub-question Sub-Q1. Subsequently, each candidate inferred answer set Sub-Ans1(j) is provided as a bridge for a second sub-question Sub-Q2* to generate a verification question New-Sub-Q2*(j). The search operation 604 and the document reading operation 605 for verification are performed for the verification question New-Sub-Q2*(j), and when the verification question New-Sub-Q2*(j) passes through the verification, the candidate inferred answer Sub-Ans1(j) is determined as a final answer. This candidate inferred answer verification process is repeated for each candidate inferred answer. For reference, this process is similar to a bridge reasoning pipeline.

Specifically, in the example given through FIG. 5, it is to be noted that “Who were the lead actors in Office Upspring?” is selected as a first sub-question. In other words, a question decomposition module has a function of selecting a first one of two sub-questions. The first sub-question is selected in this example because the number of lead actors is usually smaller than the number of non-lead actors. In other words, a question having a smaller number of candidates is selected as a first question. In this way, the number of times that candidate answer verification is repeated can be reduced. As shown in the foregoing example, the intermediate inferred answer to “Who were the lead actors in Home and Away?” is “{Brenton Thwaites, Emily Weir}.” When a search-(verification) document reading operation is performed for a verification question for each intermediate inferred answer, that is, (1) “Was Brenton Thwaites an actor in Office Upspring?” and (2) “Was Emily Weir an actor in Office Upspring?,” the final answer “Brenton Thwaites” may be determined.

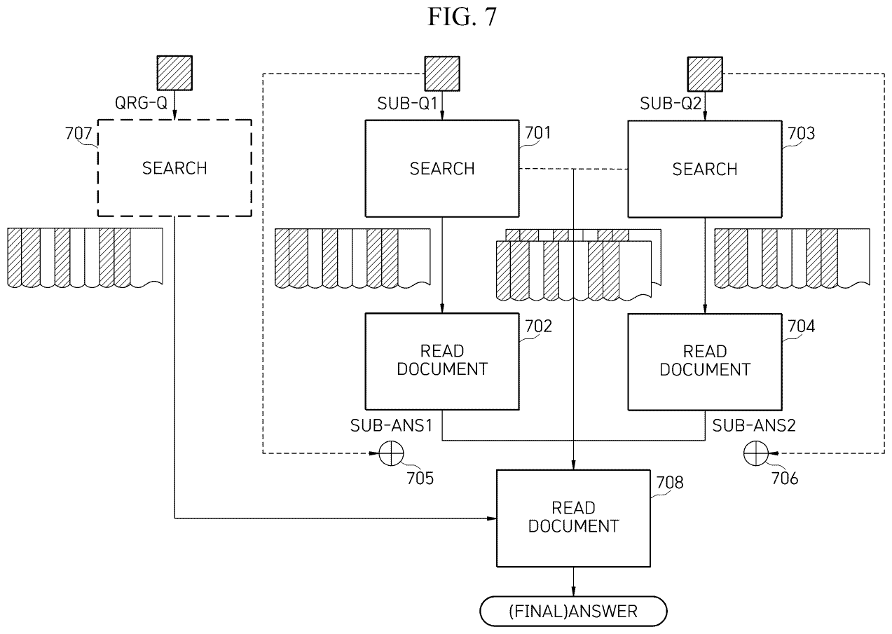

FIG. 7 is a diagram of an example of a comparative reasoning pipeline according to the exemplary embodiment of the present invention.

For example, when a reasoning type of an input question is comparison, search operations 701 and 703 each corresponding to a plurality of sub-questions and document reading operations 502 and 504 based on the search results may be performed to generate a plurality of intermediate inferred answers. Subsequently, the plurality of intermediate inferred answers are reinforced (705 and 706) with a plurality of sub-questions to generate context text, and the question and the context text are input to perform a document reading operation 708 and output a final answer. According to the exemplary embodiment of the present invention, in the document reading operation 708 of outputting the final answer, at least one of a search result 707 for the question and search results 701 and 703 for the plurality of sub-questions may be additionally input.

Referring to the example of FIG. 7, first, the search operations 701 and 703 and the document reading operations 702 and 704 are performed for two independent sub-questions Sub-Q1 and Sub-Q2 to infer intermediate inferred answers Sub-Ans1 and Sub-Ans2. The obtained intermediate inferred answers Sub-Ans1 and Sub-Ans2 are reinforced (705 and 706) with sub-questions to generate context text Sub-Q1 Sub-Ans1 and Sub-Q2 Sub-Ans2. A final answer to the original question is obtained through the final document reading module 708 using the context text. In other words, inputs to the final document reading module 708 are the original question and the context text Sub-Q1 Sub-Ans1 and Sub-Q2 Sub-Ans2. Also, the search result 707 for the original question, the search result 701 for the context text Sub-Q1 Sub-Ans1, and the search result 703 for the context text Sub-Q2 Sub-Ans2 may be additionally provided. These search results are provided to minimize error propagation that may occur in a question decomposition and sub-answer inference process.

For example, the question “Who has more LPGA wins between Seri Park and Inbee Park?” is decomposed into the sub-questions “How many LPGA championships has Seri Park won?” and “How many LPGA championships has Inbee Park won?”. These sub-questions are auxiliary questions for finding a final answer to the original question rather than simply decomposed sub-questions of the original question. In other words, question decomposition for a comparative question is actually generating auxiliary questions. In the subsequent operation, intermediate inferred answers “25 times” and “21 times” to the sub-questions are inferred. Context text based on the intermediate inferred answers reinforced with the sub-questions is “How many LPGA championships has Seri Park won? 25 times. How many LPGA championships has Inbee Park won? 21 times.” When the context text is input for final document reading with “Who has more LPGA wins between Seri Park and Inbee Park?” the final answer “Seri Park” may be inferred.

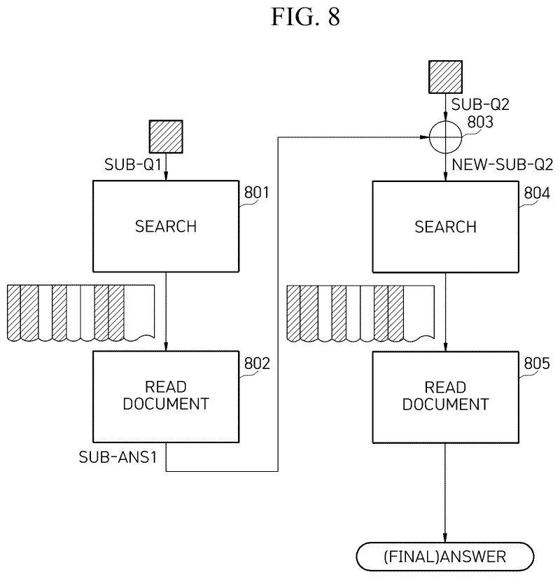

FIG. 8 is a diagram of an example of a simple bridge reasoning pipeline according to the exemplary embodiment of the present invention.

As an example, when a reasoning type of an input question is simple bridge, a search operation 801 for a first sub-question and a document reading operation 802 based on the search result may be performed to generate a first intermediate inferred answer. Subsequently, the first intermediate inferred answer is combined with a bridge anaphor of a second sub-question (803) to generate a new second sub-question, and a search operation 804 for the new second sub-question and a document reading operation 805 based on the search result may be performed to output a final answer.

Specifically, simple bridge questions include bridges therein. It is necessary to decompose a simple bridge question into two sub-questions. In this case, there is the order of sub-questions. In other words, a question decomposition module has a function of determining the order of sub-questions. A first sub-question is for finding a bridge, and a second sub-question is a question about the bridge. In other words, an intermediate answer Sub-Ans1 is found through the search operation 801 and the document reading operation 802 for a first sub-question.

The intermediate answer Sub-Ans1 is used as a bridge to infer an answer to the second sub-question Sub-Q2. In other words, a bridge anaphor of the second sub-question Sub-Q2 is replaced with the intermediate answer Sub-Ans1 (803). The newly generated sub-question may be referred to as New-Sub-Q2.

According to the exemplary embodiment of the present invention, the first intermediate inferred answer is not combined with the anaphor of the second sub-question Sub-Q2 but is added to the front end of the second sub-question Sub-Q2 to generate a new second sub-question. In other words, in the example of FIG. 8, the new sub-question New-Sub-Q2 may be generated not by replacing the bridge anaphor but by adding the intermediate answer Sub-Ans1 in front of the second sub-question Sub-Q2. The search operation 804 and the document reading operation 805 are performed for the new sub-question New-Sub-Q2 to find a final answer.

It is to be noted that such an inference is a representative chain of reasoning. Naturally, intersectional reasoning and comparative reasoning may also be considered a chain of reasoning because answers to sub-questions are found first and then a final answer is found using the answers. Also, in the document reading operation of finding the final answer, a search result for the new sub-question New-Sub-Q2 may be provided as an additional input.

To find the final answer, the original question Org-Q may be used instead of the new sub-question New-Sub-Q2. The reason is that an error may be included during question decomposition and the new sub-question New-Sub-Q2 may be replaced with the original question Org-Q. Also, when the original question Org-Q is used, a search result for the original question Org-Q may be also used in document reading for finding the final answer.

For example, the question “In which city the university where President Joe Biden earned his undergraduate degree is located?” may be determined as a simple bridge question having the university as a bridge. In this case, a first sub-question is “Which university did President Joe Biden earned his undergraduate degree from?,” and a second sub-question is “In which city is the university located?.” The intermediate answer Sub-Ans1 “University of Delaware” is inferred through search and document reading for the first sub-question. In the second sub-question Sub-Q2, the bridge anaphor “the university” is replaced with the intermediate answer Sub-Ans1 to generate the new second sub-question New-Sub-Q2 “In which city is the University of Delaware?.” Finally, the final answer “New York, Delaware” is inferred through search and document reading for the new second sub-question New-Sub-Q2.

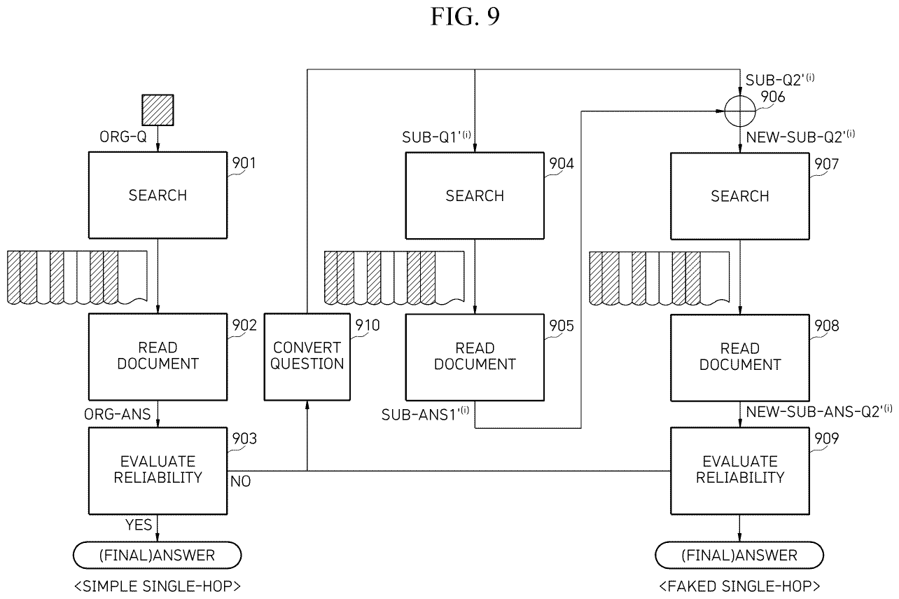

FIG. 9 is a diagram of an example of a single-hop pipeline according to the exemplary embodiment of the present invention.

Single-hop retrieval questions include two sub-types of questions, simple single-hop retrieval questions and faked single-hop retrieval questions. When a question is classified as a single-hop retrieval question, it is unnecessary to decompose the question in a first operation. Therefore, according to the exemplary embodiment of the present invention, a search operation 901 for an input question and a document reading operation 902 based on the search result may be performed to generate an inferred answer. Subsequently, the confidence level of the inferred answer is evaluated (903), and when the confidence level of the inferred answer is a preset threshold or more, the inferred answer is output as a final inferred answer.

In other words, in the example of FIG. 9, an answer Org-Ans to an original question Org-Q is inferred through a search operation 901 and a document reading operation 902. Subsequently, it is determined whether the inferred answer Org-Ans is suitable for the original question Org-Q by evaluating confidence level (903). In this confidence level evaluation (903), the question and a search paragraph may be also used along with the inferred answer. Subsequently, when high enough confidence level is ensured in the confidence level evaluation, the inferred answer Org-Ans is determined as a final answer. This process is simple single-hop retrieval reasoning.

Unlike this, according to the exemplary embodiment of the present invention, when the confidence level of the inferred answer is less than the preset threshold, the original question Org-Q corresponds to a faked single-hop retrieval question, and it is necessary to generate new sub-questions through a question conversion operation. In other words, a search operation 904 for a first sub-question generated through the question conversion operation and a document reading operation 905 based on the search result may be performed to generate a first intermediate inferred answer, and the first intermediate inferred answer is combined with a bridge anaphor of a second sub-question generated through the question conversion operation (906) to generate a new second sub-question. Subsequently, a search operation 907 for the new second sub-question and a document reading operation 908 based on the search result are performed to generate a second intermediate inferred answer, and the confidence level of the second intermediate inferred answer is evaluated (909). Subsequently, when the confidence level of the second intermediate inferred answer is the preset threshold or more, the second intermediate inference value is output as a final inferred answer.

Referring to the example of FIG. 9, when the confidence level of the inferred answer to the original question is not high enough, bridge-type new sub-questions Sub-Q1′ and Sub-Q2′ are generated through a question conversion operation. The subsequent process is the same as a simple bridge reasoning process. However, this differs from simple bridge reasoning in that, after document reading, the confidence level of an inferred answer New-Sub-Ans2′ to a new second sub-question New-Sub-Q2′ is evaluated (909).

When the confidence level obtained in the confidence level evaluation (909) is high enough, the answer to the new second sub-question New-Sub-Q2′ is determined as a final answer. Unlike this, when the confidence level is not high enough, the process returns to a question conversion module 910, and bridge reasoning is repeated. This process is named a question conversion-based bridge reasoning process. In the case of an i^{th} iteration, corresponding sub-questions may be indicated by Sub-Q1′(i) and Sub-Q2′(i) as shown in FIG. 9. Question conversion-based bridge reasoning process may be limited to a maximum of I (I is a natural number) iterations. Also, question conversion-based bridge reasoning process is the same as a single bridge reasoning process, and thus all conversion processes proposed in the simple bridge reasoning process are applicable.

Application examples of fake bridge reasoning are as follows. The original question “In which city Marine Tactical Air Command Squadron 28 is located?” may be considered a single-hop retrieval question. However, in the case of searching external knowledge data source documents, only the name of an area rather than a city in which “Marine Tactical Air Command Squadron 28” is located may be obtained. Then, an inferred answer Org-Ans, for example, “Charlotte, North Carolina” is assumed to be obtained as an incorrect answer. In this case, the confidence level obtained in confidence level evaluation is not high enough. Accordingly, the process proceeds to a question conversion-based bridge reasoning process.

In other words, question-conversion-type sub-questions Sub-Q1′ and Sub′Q2′ are generated through the question conversion module. For example, the first sub-question “What is the name of the area in which Marine Tactical Air Command Squadron 28 is located?” and the second sub-question “What city is the area located in?” are generated. Assuming that an inferred answer to the first sub-question is “Maine Corps Air Station Cherry Point,” the new second sub-question New-Sub-Q2′ “In which city is Maine Corps Air Station Cherry Point located?” is generated. A search operation and a document reading operation are performed for the new second sub-question New-Sub-Q2′ to obtain the inferred answer “Havelock, North Carolina.” Confidence level of the inferred answer is evaluated, and when the confidence level is high enough, the inferred answer is output as a final answer. When the confidence level of the inferred answer is not high enough, the question conversion-based bridge reasoning process is repeated.

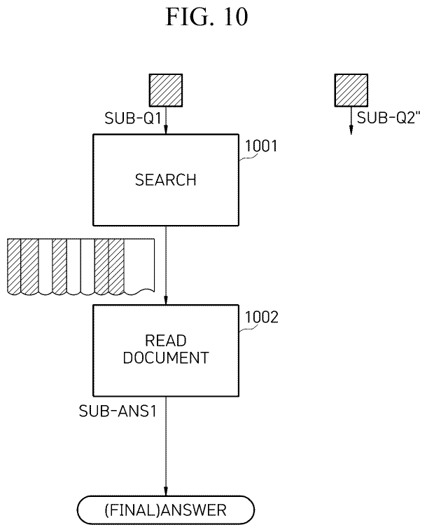

FIG. 10 is a diagram of an example of a distracted single-hop retrieval reasoning pipeline according to the exemplary embodiment of the present invention.

According to an exemplary embodiment, when a reasoning type of an input question is distracted single-hop retrieval, the input question may be decomposed into a sub-question and a declarative sentence, and a search operation 1001 for the sub-question rather than the declarative sentence and a document reading operation 1002 based on the search result may be performed to generate a final answer.

A distracted single-hop retrieval question indicates a question of which a final answer may be actually found using only one of sub-questions. The other sub-question is unnecessary to actually find an answer. More specifically, the other sub-question is not a question but a declarative sentence. In other words, the distracted single-hop retrieval question may be decomposed into two sentences, that is, a question and a declarative sentence. The original question including all content includes several conditions and thus may hinder an accurate search. Therefore, unnecessary information may be removed through question decomposition.

For example, the original question “In which TV series did the actress Jiwon Kim, one of the stars of What's up, come to prominence?” may be decomposed into the sub-question “In which TV series did the actress Jiwon Kim come to prominence?” and the declarative sentence “The actress Jiwon Kim was one of the stars of What's up.” A search operation and a document reading operation are performed for only the sub-question “In which TV series did the actress Jiwon Kim come to prominence?” rather than the declarative sentence to infer the final answer “The Heirs.”

Meanwhile, in the above description, operations S310 to S340 may be further decomposed into sub-operations or combined into fewer operations. Also, some operations may be omitted as necessary, and the order of operations may be changed. In addition, the description of FIG. 1 and those of FIGS. 2 to 10 may be applied to each other.

The above-described embodiments of the present invention may be implemented as a program (or application) and stored in a medium to be executed in combination with a computer which is hardware.

The foregoing program may include code written in a computer language, such as C, C++, JAVA, Ruby, machine language, or the like, which can be read by a processor (central processing unit (CPU)) of the computer through a device interface of the computer, to execute the methods implemented as programs read by the computer. Such code may include functional code related to a function for defining functions required for executing the methods and include execution procedure-related control code required for the processor of the computer to execute the functions according to a certain procedure. Also, such code may further include additional information required for the processor of the computer to execute the functions or a memory reference-related code indicating the position (address) of an internal or external memory of the computer which will refer to a medium. Further, when the processor of the computer needs to communicate with another remote computer, server, or the like to execute the functions, the code may further include communication-related code indicating how to communicate with another computer, server, or the like using a communication module of the computer, which information or medium will be transmitted during communication, or the like.

The stored medium does not indicate a medium, such as a register, a cache, a memory, or the like, which stores data for a short moment, but indicates a medium which semi-permanently stores data and can be read by a device. Specifically, examples of the storage medium include, but are not limited to, a ROM, a random access memory (RAM), a CD-ROM, magnetic tape, floppy disk, an optical data storage device, and the like. In other words, the program may be stored in various recording media of various servers which the computer may access or various recording media of a user's computer. In addition, the media may store code which may be distributed across computer systems connected through a network and read by computers in a distributed manner.

According to an exemplary embodiment of the present invention described above, it is possible to perform QA for complex reasoning in an open domain using a small or medium-sized language model. Also, it is possible to mitigate the problems of hallucination and knowledge being outdated in large language models using a search-and-document-reading structure as a backbone,

An exemplary embodiment of the present invention can provide the best inference performance suitable for a characteristic of each question type by providing an optimal reasoning pipeline which has separate complex solutions to complex question types.

According to an exemplary embodiment of the present invention, it is possible to decompose a complex question into sub-questions for a chain of reasoning using a pipeline based on a small or medium-sized model and generate an auxiliary question To determine an optimal action for a next operation, an answer can be evaluated, and whether to proceed to the next operation can be determined.

According to an exemplary embodiment of the present invention, a pipeline based on a small or medium-sized model may be subjected to fine-tuned training for each type of reasoning. Accordingly, it is possible to effectively build an optimized reasoning pipeline and significantly reduce operational costs using a small or medium-sized model versus a large language model, thereby improving efficiency.

Effects of the present invention are not limited to those described above, and other effects which have not been described will be clearly understood by those of ordinary skill in the art from the above description.

The above description of the present invention is illustrative, and those skilled in the art to which the present invention pertains will understand that the present invention can be easily modified into other specific forms without changing the technical spirit or essential features of the present invention. Therefore, it is to be understood that the above-described embodiments are only illustrative in all aspect and are not limiting. For example, components described in a singular form may be embodied in a distributed manner. Similarly, components described as being distributed may be embodied in a combined form.

The scope of the present invention is defined by the claims to be described below rather than the detailed description, and it is to be construed that the meaning and scope of the claims and all changes or modifications derived from the equivalent concept thereof fall within the scope of the present invention.

What is claimed is:

1. A question answering method based on a complex reasoning pipeline, the question answering method comprising:
classifying a reasoning type of an input question;
generating sub-questions by decomposing the input question;
inputting the sub-questions to a reasoning pipeline corresponding to the reasoning type; and
outputting a final answer corresponding to the input sub-questions from the reasoning pipeline,
wherein the reasoning pipeline includes a search module configured to perform a search corresponding to each of the decomposed sub-questions and a document reading module configured to perform a document reading process according to search results.

2. The question answering method of claim 1, wherein the classifying of the reasoning type of the input question comprises classifying the input question as any one reasoning type among comparison, intersection, simple bridge, single-hop retrieval, and distracted single-hop retrieval.

3. The question answering method of claim 2, wherein the outputting of the final answer corresponding to the input sub-questions from the reasoning pipeline comprises, when the reasoning type of the input question is intersection:
performing a search corresponding to each of the plurality of sub-questions and a document reading operation based on a search result to generate a plurality of intermediate inferred answers; and
performing intersectional reasoning on the plurality of intermediate inferred answers to output the final answer.

4. The question answering method of claim 2, wherein the outputting of the final answer corresponding to the input sub-questions from the reasoning pipeline comprises, when the reasoning type of the input question is intersection:
performing a search for a first sub-question and a document reading operation based on a search result to generate a first candidate inferred answer set;
combining each first candidate inferred answer with a bridge anaphor of a second sub-question for verifying the first candidate inferred answer set to generate a new verification question; and
performing a search for the new verification question and determining, as the final answer, an inference which is passed through a document reading operation for verification based on a search result.

5. The question answering method of claim 2, wherein the outputting of the final answer corresponding to the input sub-questions from the reasoning pipeline comprises, when the reasoning type of the input question is comparison:
performing a search corresponding to each of the plurality of sub-questions and a document reading operation based on a search result to generate a plurality of intermediate inferred answers;
reinforcing the plurality of intermediate inferred answers with the plurality of sub-questions to generate context text; and
receiving the question and the context text and performing a document reading operation to output the final answer.

6. The question answering method of claim 5, wherein the receiving of the question and the context text and the performing of the document reading operation to output the final answer further comprise additionally inputting at least one of a search result for the question and search results for the plurality of sub-questions.

7. The question answering method of claim 2, wherein the outputting of the final answer corresponding to the input sub-questions from the reasoning pipeline comprises, when the reasoning type of the input question is simple bridge:
performing a search for a first sub-question and a document reading operation based on a search result to generate a first intermediate inferred answer;
combining a first intermediate inferred answer with a bridge anaphor of a second sub-question to generate a new second sub-question; and
performing a search for the new second sub-question and a document reading operation based on a search result to output the final answer.

8. The question answering method of claim 7, wherein the combining of the first intermediate inferred answer with the bridge anaphor of the second sub-question to generate the new second sub-question comprises combining the first intermediate inferred answer not with the bridge anaphor of the second sub-question but in front of the second sub-question to generate the new second sub-question.

9. The question answering method of claim 2, wherein the outputting of the final answer corresponding to the input sub-questions from the reasoning pipeline comprises, when the reasoning type of the input question is single-hop retrieval:
performing a search for the input question and a document reading operation based on a search result to generate an inferred answer;
evaluating a confidence level of the inferred answer; and
when the confidence level of the inferred answer a preset threshold or more, outputting the inferred answer as a final inferred answer.

10. The question answering method of claim 9, wherein the outputting of the final answer corresponding to the input sub-questions from the reasoning pipeline comprises, when the confidence level of the inferred answer is less than the preset threshold:
performing a search for a first sub-question generated through a question conversion operation and a document reading operation based on a search result to generate a first intermediate inferred answer;
combining the first intermediate inferred answer with a bridge anaphor of a second sub-question generated through the question conversion operation to generate a new second sub-question;
performing a search for the new second sub-question and a document reading operation based on a search result to generate a second intermediate inferred answer;
evaluating a confidence level of the second intermediate inferred answer; and
when the confidence level of the second intermediate inferred answer is the preset threshold or more, outputting the second intermediate inferred answer as a final inferred answer.

11. The question answering method of claim 10, wherein the outputting of the final answer corresponding to the input sub-questions from the reasoning pipeline further comprises, when the confidence level of the second intermediate inferred answer is less than the preset threshold:
reperforming the question conversion operation to generate the first sub-question, the first intermediate inferred answer, the second sub-question, and the second intermediate inferred answer again; and
re-evaluating the confidence level of the second intermediate inferred answer.

12. The question answering method of claim 2, wherein, when the reasoning type of the input question is distracted single-hop retrieval, the generating of the sub-questions by decomposing the input question comprises decomposing the input question into a sub-question and a declarative sentence, and
the outputting of the final answer corresponding to the input sub-questions from the reasoning pipeline further comprises performing a search for the sub-question rather than the declarative sentence and a document reading operation based on a search result to generate the final answer.

13. A question answering system based on a complex reasoning pipeline, the question answering system comprising:
an input part configured to receive a question;
a memory configured to store a program for inferring from the received question and outputting an answer; and
a processor configured to execute the program stored in the memory,
wherein, when the program is executed, the processor classifies a reasoning type of the received question, generates sub-questions by decomposing the received question, inputs the sub-questions to a reasoning pipeline corresponding to the reasoning type, and outputs a final answer corresponding to the input sub-questions from the reasoning pipeline, and
the reasoning pipeline includes a search module configured to perform a search corresponding to each of the decomposed sub-questions and a document reading module configured to perform a document reading process according to search results.
